(19) United States
(12) Patent Application Publication
(10) Pub. No.: US 2011/0244355 A1
(43) Pub. Date: Oct. 6, 2011

(54) FUEL CELL STACK COMPRESSION ENCLOSURE APPARATUS

(75) Inventor: Glenn W. Skala, Churchville, NY (US)

(73) Assignee: GM GLOBAL TECHNOLOGY OPERATIONS, INC., Detroit, MI (US)

(21) Appl. No.: 12/752,194

(22) Filed: Apr. 1, 2010

(51) Int. Cl. H01M 8/24; H01M 8/00

(52) U.S. Cl. 429/468; 29/623.1

(57) ABSTRACT

A fuel cell system is provided including a fuel cell stack including at least one fuel cell, a first compression plate disposed adjacent the fuel cell stack, a second compression plate disposed adjacent the fuel cell stack, and a compression enclosure apparatus. The compression enclosure apparatus comprises a unitary main body having first and second fastening points and an intermediate portion, wherein the first fastening point and the second fastening point are coupled to the first compression plate and the intermediate portion is disposed adjacent the second compression plate. The fuel cell system minimizes a number of components required to retain compression of the fuel cell stack, minimizes a mass of the fuel cell system, and simplifies a design of the fuel cell system. Also provided is a method for assembling the fuel cell system.

### FIELD OF THE INVENTION

The present invention relates generally to a fuel cell system, and, more particularly to a compression enclosure apparatus for the fuel cell system.

### BACKGROUND OF THE INVENTION

A fuel cell has been proposed as a clean, efficient and environmentally responsible power source for electric vehicles and various other applications. In particular, the fuel cell has been identified as a potential alternative for the traditional internal-combustion engine used in modern vehicles. In proton exchange membrane (PEM) type fuel cells, hydrogen is supplied as a fuel to an anode of the fuel cell and oxygen is supplied as an oxidant to a cathode of the fuel cell. The fuel cell includes a unitized electrode assembly (UEA) disposed between a pair of separator plates. The UEA generally comprises an insulating gasket, a solid polymer membrane electrolyte having a catalyst and an electrode on both faces of the membrane electrolyte, and conductive gas diffusion media disposed against both faces of the membrane electrolyte. A plurality of fuel cells is stacked together to form a fuel cell stack.

The fuel cell stack is generally loaded in compression in order to seal the fuel cells and maintain a low interfacial electrical contact resistance between the separator plates, the gas diffusion media, and the catalyst electrode. The low interfacial contact resistance in a PEM fuel cell stack is directly related to the compression loading. Typically, compression loads on the fuel cell stack range from about 50 to about 400 psi and are controlled by a compression retention system.

The compression retention system typically includes a plurality of components coupled together and cooperating to retain compression on the fuel cell stack. Conventional compression systems have consisted of tie rods extending through and between end plate assemblies secured with fastening nuts. Springs threaded on the tie rods and interposed between the fastening nuts and the end plates are used to apply a resilient compressive force to fuel cell stacks in a stacking direction. The conventional compression retention system including the plurality of components is bulky and costly.

The conventional compression retention system including the plurality of components increases a mass of the fuel cell system. The fuel cell stack including the compression retention system is typically shielded against contamination by placing the fuel cell stack into a protective enclosure. The protective enclosure may also contain electromagnetic interference given off by the fuel cell stack. A mounting structure is also typically coupled to the fuel cell stack to facilitate coupling the fuel cell stack to a vehicle chassis or other structure. A plurality of distinct sub-assemblies, such as the conventional compression retention system, the protective enclosure, and the mounting structure increases the mass of the fuel cell system.

Further, the fuel cell system including the conventional compression retention system, the protective enclosure, and the mounting structure results in the fuel cell system having a complex design. The complex design undesirably increases an assembly time as each of the conventional compression retention system, the protective enclosure, and the mounting structure are individually attached to the fuel cell system. A number of fasteners used to couple the plurality of distinct sub-assemblies to the fuel cell system is also undesirably increased. Further, the plurality of distinct sub-assemblies may need to be removed from the fuel cell system in a particular order to facilitate servicing thereof, increasing a service time of the fuel cell system. The plurality of distinct sub-assemblies results in a complex design, increasing the assembly time, the number of fasteners used, and the service time of the fuel cell system.

It would be desirable to develop a compression enclosure apparatus for a fuel cell system, wherein the compression enclosure apparatus minimizes a number of components required to retain compression of a fuel cell stack, minimizes a mass of the fuel cell system, and simplifies a design of the fuel cell system.

### SUMMARY OF THE INVENTION

Presently provided by the invention, a compression enclosure apparatus for a fuel cell system that minimizes a number of components required to retain compression of a fuel cell stack, minimizes a mass of the fuel cell system, and simplifies a design of the fuel cell system, has surprisingly been discovered.

In a first embodiment, the fuel cell system comprises a fuel cell stack having a first end and a second end, the stack including at least one fuel cell, a first compression plate disposed adjacent the first end of the fuel cell stack, a second compression plate disposed adjacent the second end of the fuel cell stack, and a compression enclosure apparatus further comprising a unitary main body having a first fastening point, a second fastening point, and an intermediate portion, wherein the first fastening point and the second fastening point are coupled to the first compression plate and the intermediate portion is disposed adjacent the second compression plate.

In another embodiment, the fuel cell system comprises a fuel cell stack having a first end and second end, the stack including at least one fuel cell, a first compression plate disposed adjacent the first end of the fuel cell stack, a second compression plate disposed adjacent the second end of the fuel cell stack, and a generally U-shaped compression enclosure apparatus further comprising a unitary main body having at least one first tab formed in a first end thereof, at least one second tab formed in a second end thereof, and an intermediate portion, wherein the at least one first tab and the at least one second tab are coupled to the first compression plate and the intermediate portion is disposed adjacent the second compression plate.

The invention also provides methods for assembling a fuel cell system.

In one embodiment, the method comprises steps of providing a providing a compression enclosure apparatus having a unitary main body with a first fastening point, a second fastening point, and an intermediate portion, providing a first compression plate, providing a fuel cell stack having a first end and second end, the stack comprising at least one fuel cell, providing a second compression plate, disposing the second compression plate in the compression enclosure apparatus, disposing the fuel cell stack in the compression enclosure apparatus, the second end of the fuel cell stack disposed against the second compression plate, disposing the first compression plate against the first end of the fuel cell stack, applying a compressive load to one of the first compression plate and the compression enclosure apparatus to compress the fuel cell stack, coupling the compression enclosure apparatus to the first compression plate, and removing the compressive load.

### BRIEF DESCRIPTION OF THE DRAWINGS

The above, as well as other advantages of the present invention, will become readily apparent to those skilled in the art from the following detailed description of the invention when considered in the light of the accompanying drawings in which:

FIG. 1 illustrates a schematic, exploded perspective view of a PEM fuel cell stack (only two cells shown);

FIG. 2 is a partially exploded perspective view showing a fuel cell system having a compression enclosure apparatus according to an embodiment of the invention;

FIG. 3 is a perspective view showing the fuel cell system of FIG. 2 in an assembled state;

FIG. 4 is a front elevational view of the compression enclosure apparatus illustrated in FIGS. 2 and 3;

FIG. 5 is a side elevational view of the compression enclosure apparatus illustrated in FIGS. 2 and 3;

FIG. 6 is a front elevational view of a compression enclosure apparatus according to another embodiment of the invention;

FIG. 7 is a side elevational view of the compression enclosure apparatus illustrated in FIG. 6; and

FIG. 8 is a perspective view showing a fuel cell system having a compression enclosure apparatus according to another embodiment of the invention.

### DETAILED DESCRIPTION OF THE INVENTION

The following description is merely exemplary in nature and is not intended to limit the present disclosure, application, or uses. It should be understood that throughout the drawings, corresponding reference numerals also indicate like or corresponding parts and features. In respect of the method disclosed, the steps presented are exemplary in nature, and thus, are not necessary or critical.

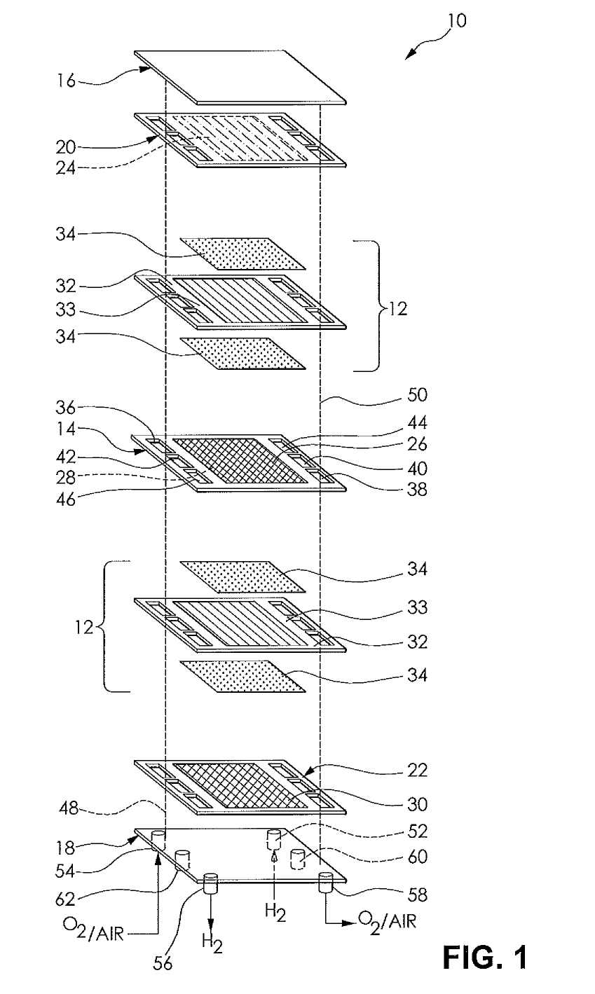

FIG. 1 depicts a fuel cell stack 10 having a pair of unitized electrode assemblies 12 separated from each other by an electrically conductive bipolar plate 14. For simplicity, only a two-cell stack (i.e. one bipolar plate) is illustrated and described in FIG. 1, it being understood that the typical fuel cell stack 10 will have many more cells and bipolar plates.

The unitized electrode assemblies 12 and bipolar plate 14 are stacked together between a pair of clamping plates 16, 18 and a pair of unipolar end plates 20, 22. The clamping plates 16, 18 are typically electrically insulated from the end plates 20, 22 by a seal or a dielectric coating (not shown). The unipolar end plate 20, both working faces of the bipolar plate 14, and the unipolar end plate 22 include respective active areas 24, 26, 28, 30. The active areas 24, 26, 28, 30 are typically flow fields for distributing gaseous reactants such as hydrogen gas and air over an anode and a cathode, respectively, of the unitized electrode assemblies 12.

The bipolar plate 14 is typically formed by a conventional process for shaping sheet metal such as stamping, machining, molding, or photo etching through a photolithographic mask, for example. In one embodiment, the bipolar plate 14 is formed from unipolar plates which are then joined by any conventional process such as welding or adhesion. It should be further understood that the bipolar plate 14 may also be formed from a composite material. In one particular embodiment, the bipolar plate 14 is formed from a graphite or graphite-filled polymer.

A plurality of nonconductive gaskets 32, which may be a component of a plurality of membrane electrode assemblies 33, militates against fuel cell leakage and provides electrical insulation between the several components of the fuel cell stack 10. Gas-permeable diffusion media 34 are disposed adjacent the membrane electrode assemblies 33, which collectively form the unitized electrode assemblies 12. The end plates 20, 22 are also disposed adjacent the diffusion media 34, respectively, while the active areas 26, 28 of the bipolar plate 14 are disposed adjacent the diffusion media 34.

The bipolar plate 14, unipolar end plates 20, 22, and the unitized electrode assemblies 12 each include a cathode supply aperture 36 and a cathode exhaust aperture 38, a coolant supply aperture 40 and a coolant exhaust aperture 42, and an anode supply aperture 44 and an anode exhaust aperture 46. Supply headers 48 and exhaust headers 50 of the fuel cell stack 10 are formed by an alignment of the respective apertures 36, 38, 40, 42, 44, 46 in the bipolar plate 14, unipolar end plates 20, 22, and the unitized electrode assemblies 12. The hydrogen gas is supplied to an anode supply header via an anode inlet conduit 52. The air is supplied to a cathode supply header of the fuel cell stack 10 via a cathode inlet conduit 54. An anode outlet conduit 56 and a cathode outlet conduit 58 are also provided for an anode exhaust header and a cathode exhaust header, respectively. A coolant inlet conduit 60 is provided for supplying liquid coolant to a coolant supply header. A coolant outlet conduit 62 is provided for removing coolant from a coolant exhaust header. It should be understood that the configurations of the various inlets 52, 54, 60 and outlets 56, 58, 62 in FIG. 1 are for the purpose of illustration, and other configurations may be chosen as desired.

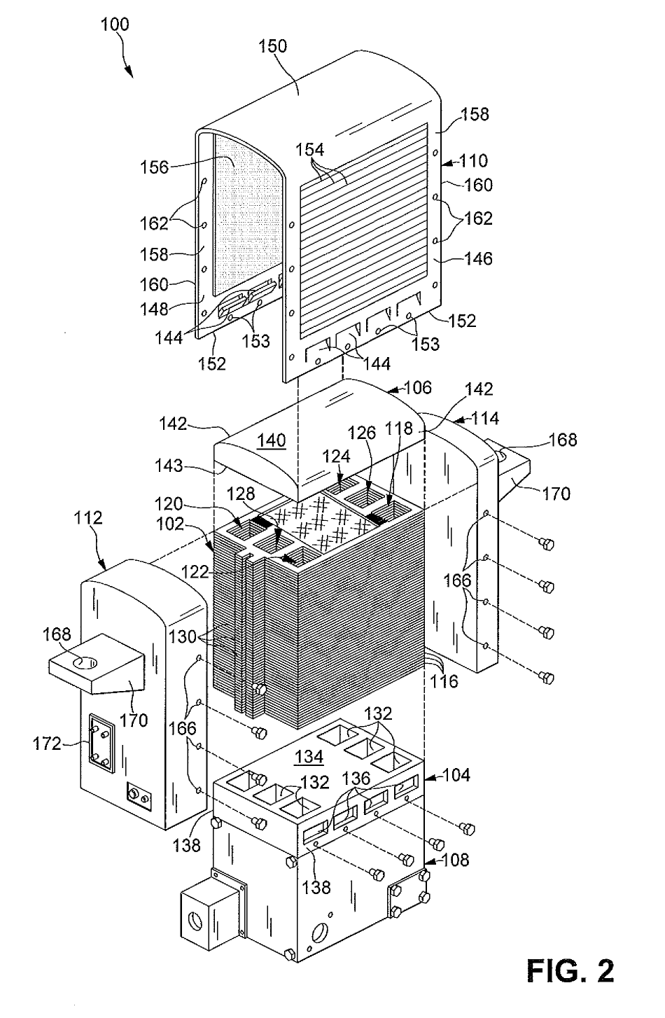

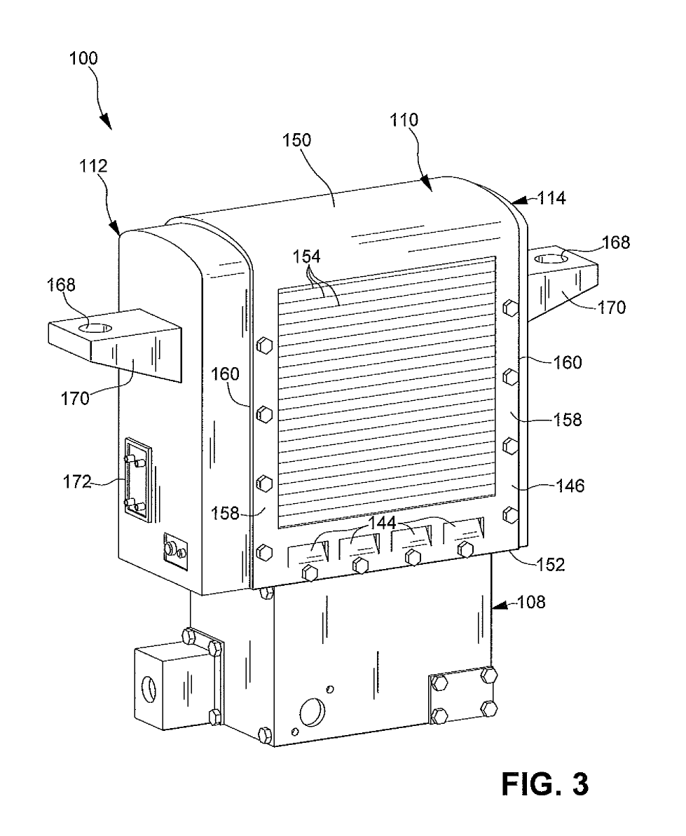

In FIGS. 2 and 3, one embodiment of a fuel cell system 100 according to the present invention is shown. The fuel cell system 100 has a fuel cell stack 102 disposed between a first compression plate 104 and a second compression plate 106. A lower end unit 108 is disposed adjacent the first compression plate 104. A compression enclosure apparatus 110 is disposed on the second compression plate 106 and is coupled to the first compression plate 104. A first rigid structure 112 and a second rigid structure 114 are disposed adjacent the fuel cell stack 102 and coupled to the compression enclosure apparatus 110.

The fuel cell stack 102 includes a plurality of bipolar plates 116 having a plurality of unitized electrode assemblies disposed therebetween. A plurality of manifolds is formed by an alignment of apertures formed in the plates 116. The plurality of manifolds includes an anode supply manifold 118, an anode exhaust manifold 120, a cathode supply manifold 122, a cathode exhaust manifold 124, a coolant supply manifold 126, and a coolant exhaust manifold 128. Each of the manifolds 118, 120, 122, 124, 126, 128 is in fluid communication with the first compression plate 104 and the lower end unit 108. The bipolar plates 116 are in electrical communication with the first rigid structure 112 or a component disposed therein via a plurality of contacts 130 formed on each of the plates 116. A first end of the fuel cell stack 102 is disposed adjacent the first compression plate 104 and a second end of the fuel cell stack 102 is disposed adjacent the second compression plate 106.

The first compression plate 104 is a rigid body having a substantially rectangular prism shape, but any shape may be used. A plurality of fasteners (not shown) couple the first compression plate 104 to the lower end unit 108, but other coupling devices may be used. The first compression plate 104 is formed from a rigid material such as a steel, aluminum, or other material as desired. The first compression plate 104 is designed to withstand several tons of compressive force. It should be recognized that the first compression plate 104 may be combined with the lower end unit 108.

A plurality of fluid ports 132 is formed through the first compression plate 104, on a plate abutment face 134 of the first compression plate 104. Each of the ports 132 facilitates fluid communication between the plurality of manifolds 118, 120, 122, 124, 126, 128 and the lower end unit 108. A plurality of retention apertures 136 is formed in side faces 138 of the first compression plate 104. As shown, four retention apertures 136 are formed in each of the side faces 138, but any other number of retention apertures 136 may be used.

The second compression plate 106 is a substantially rigid body. The second compression plate 106 is formed from a rigid material such as a steel, aluminum, or other material as desired. Alternately, the second compression plate 106 may be formed from a plurality of rigid materials. The second compression plate 106 is designed to withstand several tons of compressive force. A top face 140 of the second compression plate 106 is arch-shaped to allow a tangential transition from the top face 140 to each side face 142 of the second compression plate 106. A lower face 143 is a substantially planar face of the second compression plate 106 abutting the fuel cell stack 102.

The lower end unit 108 is coupled to the first compression plate 104 and is in fluid communication with the first compression plate 104 and the fuel cell stack 102. The lower end unit 108 houses at least one, and in particular embodiments more than one, fuel cell subsystem and related devices (not shown) involved in preconditioning and operation of the fuel cell stack 102. As nonlimiting examples, the fuel cell subsystem housed within the lower end unit 108 can include fluid passages, hydrogen fuel and oxidant (O₂/air) passages, cooling pumps, recirculation pumps, drainage valves, insulation, fans, compressors, valves, electrical connections, reformers, humidifiers, and related instrumentation. It should be recognized that additional fuel cell subsystems and/or peripheral devices used in support of the fuel cell system 100 can also be housed in the lower end unit 108.

The compression enclosure apparatus 110 is a substantially U-shaped unitary main body typically formed from a sheet metal. The compression enclosure apparatus 110 may be formed by stamping and bending a piece of sheet metal, but other processes may be used. The compression enclosure apparatus 110 may be formed from a material that militates against a transfer of electromagnetic interference therethrough and typically has a thickness able to withstand several tons of tensile force applied thereto. The thickness of the compression enclosure apparatus 110 may vary as desired. As a non-limiting example, a thickness of the compression enclosure apparatus 110 along a periphery may be about 1.5 millimeters and a thickness in a central portion may be about 0.5 millimeters. A width of the compression enclosure apparatus 110 is typically greater than a width of the fuel cell stack 102. The compression enclosure apparatus 110 extends from one of the side faces 138 of the first compression plate 104 over the fuel cell stack 102 and the second compression plate 106, returning to another of the side faces 138 of the first compression plate 104.

The compression enclosure apparatus 110 includes at least one fastening point 144 formed in a first portion 146 and in a second portion 148 thereof. The first portion 146 and the second portion 148 are substantially planar. An intermediate portion 150 is formed between the first portion 146 and the second portion 148. The intermediate portion 150 is an arcuate transitionary portion of the compression enclosure apparatus 110 between the first portion 146 and the second portion 148. The fastening points 144 engage a wall forming the retention apertures 136, coupling the compression enclosure apparatus 110 to the first compression plate 104 and securing the fuel cell stack 102 and the second compression plate 106 within the compression enclosure apparatus 110.

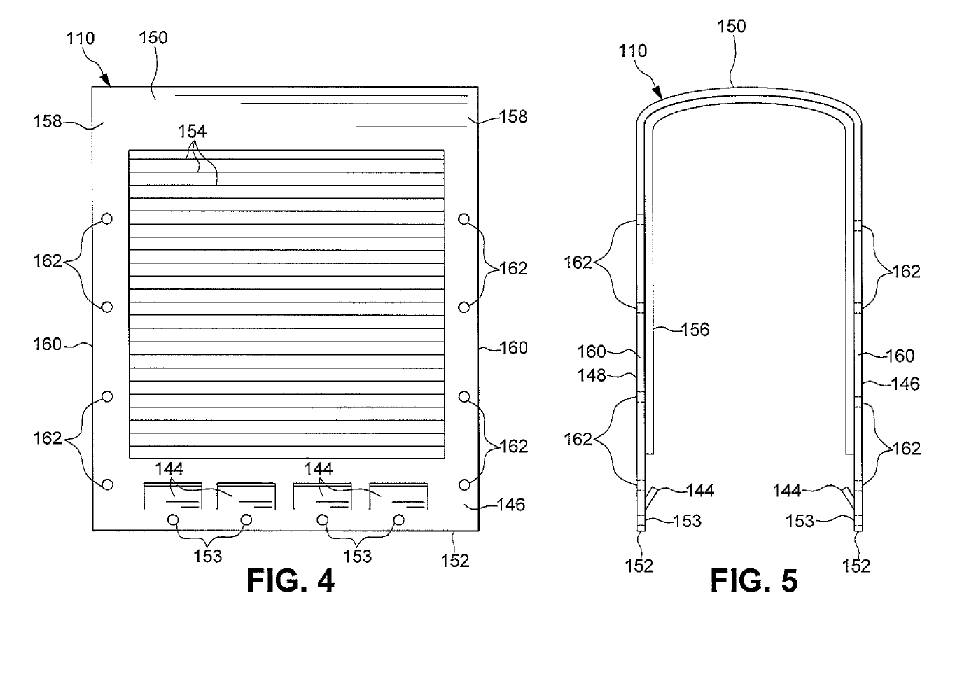

As shown in FIGS. 4 and 5, the compression enclosure apparatus 110 includes four fastening points 144 formed in the first portion 146 and four fastening points 144 formed in the second portion 148, but any number of fastening points 144 may be used. The fastening point 144 is a substantially rectangular shaped tab, the tab separated from the unitary main body along three sides thereof and bent inwardly towards the second portion 148 when formed in the first portion 146. When the fastening point 144 is formed in the second portion 148, the tab is bent inwardly towards the first portion 146. A side of the fastening point 144 connected to the unitary main body is adjacent a lower peripheral edge 152 of the compression enclosure apparatus 110. The fastening points 144 may be formed in the compression enclosure apparatus 110 using a punch and a die, where the retention apertures 136 are the die. Alternately, the fastening points 144 may be formed by any other process. The fastening points 144 may also have other shapes, such as a non-pierced depression in the unitary main body, an aperture into which a fastener is disposed, or an aperture into which a portion of the second compression plate 106 is inserted.

A plurality of apertures 153 may also be formed in the first portion 146 and the second portion 148, adjacent the lower peripheral edge 152. A plurality of fasteners disposed in the plurality of apertures 153 and coupled to the first compression plate 104 apply a force to the compression enclosure apparatus 110 adjacent the lower peripheral edge 152. Alternately, other features formed in the compression enclosure apparatus 110 or the first compression plate 104 may apply the force to the compression enclosure apparatus 110.

The intermediate portion 150 is a substantially arch-shaped portion of the unitary main body. A shape of the intermediate portion 150 substantially corresponds to a shape of the top face 140 of the second compression plate 106. The intermediate portion 150 forms a tangential transition from the first portion 146 to the second portion 148 of the unitary main body. FIG. 3 illustrates the intermediate portion 150 disposed adjacent the top face 140 of the second compression plate 106.

The compression enclosure apparatus 110 may include a plurality of rigidizing features 154 formed therein. As shown in FIGS. 2, 3, and 4, the plurality of rigidizing features 154 is a plurality of ribs integrally formed in the first portion 146 and the second portion 148 of the compression enclosure apparatus 110. Alternately, the rigidizing features 154 may be formed separate and coupled to the compression enclosure apparatus 110.

An insulating layer 156 is disposed on an inner surface of the compression enclosure apparatus 110. As shown in FIGS. 2 and 5, the insulating layer 156 is shaped to substantially conform to the inner surface of the compression enclosure apparatus 110. To form the insulating layer 156, a closed cell foam or other non-absorbent insulating material is typically cut to a predetermined size and coupled to the inner surface using an adhesive. The insulating layer 156 may be a unitary layer or may comprise a plurality of portions. Alternately, the insulating layer 156 may be formed by coupling an insulating material to the fuel cell stack 102.

The compression enclosure apparatus 110 includes a structural interface portion 158 integrally formed therewith. The structural interface portion 158 is a portion of the compression enclosure apparatus 110 extending inwardly from a lateral peripheral edge 160 to an edge of the fuel cell stack 102. As shown, the compression enclosure apparatus 110 includes two structural interface portions 158 formed on each side of the fuel cell stack 102. A plurality of peripheral apertures 162 is formed in the structural interface portions 158 adjacent the lateral peripheral edge 160.

The first rigid structure 112 and the second rigid structure 114 are coupled to the structural interface portions 158. As shown in FIGS. 2 and 3, the first rigid structure 112 and the second rigid structure 114 are disposed on opposite sides of and adjacent the fuel cell stack 102. A steel, aluminum, or other formable material is typically used to form the first rigid structure 112 and the second rigid structure 114. The first rigid structure 112 and the second rigid structure 114 may be formed using a casting process, a machining process, or any other process. It should be noted that the first rigid structure 112 and the second rigid structure 114 may be formed from similar or different materials and may be manufactured using similar or different processes. The first rigid structure 112 and the second rigid structure 114 may be a hollow body or a solid body. At least a portion of the first rigid structure 112 and the second rigid structure 114 substantially corresponds to a profile of the second compression plate 106, the fuel cell stack 102, and the first compression plate 104. The first rigid structure 112 and the second rigid structure 114 abut ends of the first compression plate 104 and the second compression plate 106. When coupled to the structural interface portions 158, the first rigid structure 112, the second rigid structure 114, and the compression enclosure apparatus 110 substantially enclose the first compression plate 104, the fuel cell stack 102, and the second compression plate 106.

A plurality of receiving elements 166 corresponding to the peripheral apertures 162 is formed in the first rigid structure 112 and the second rigid structure 114. A plurality of fasteners is disposed through the peripheral apertures 162 and into the receiving elements 166 to couple the first rigid structure and the second rigid structure 114 to the compression enclosure apparatus 110. Alternately, the first rigid structure 112 and the second rigid structure 114 may be coupled to the compression enclosure apparatus 110 using a plurality of engagement tabs and receiving apertures, crimping the lateral peripheral edges 160 of the compression enclosure apparatus 110, or using other fasteners as desired.

The first rigid structure 112 and the second rigid structure 114 include at least one mounting point 168 formed thereon. As shown in FIGS. 2 and 3, the mounting point 168 includes an aperture formed in a support member 170 coupled to the first rigid structure 112 and the second rigid structure 114. However, the mounting point 168 may be formed in any portion of the first rigid structure 112 and the second rigid structure 114. A fastener (not shown) disposed through the mounting point 168 and a cross car structure (not shown) provides support for the fuel cell system 100. However, the mounting point 168 may be coupled to any rigid body to support the fuel cell system 100.

The first rigid structure 112 and the second rigid structure 114 may include a port 172. As shown, the port 172 includes an aperture formed in the first rigid structure 112 affording access to an interior cavity of the first rigid structure 112. The port 172 may facilitate fluid, electrical, or mechanical communication with the component disposed therein. Additionally, the port 172 may facilitate electrical communication with the fuel cell stack 102. A bus bar, a stack interface unit, a stack health monitor, or other component may be disposed in the interior cavity of the first rigid structure 112 and is in electrical communication with the contacts 130.

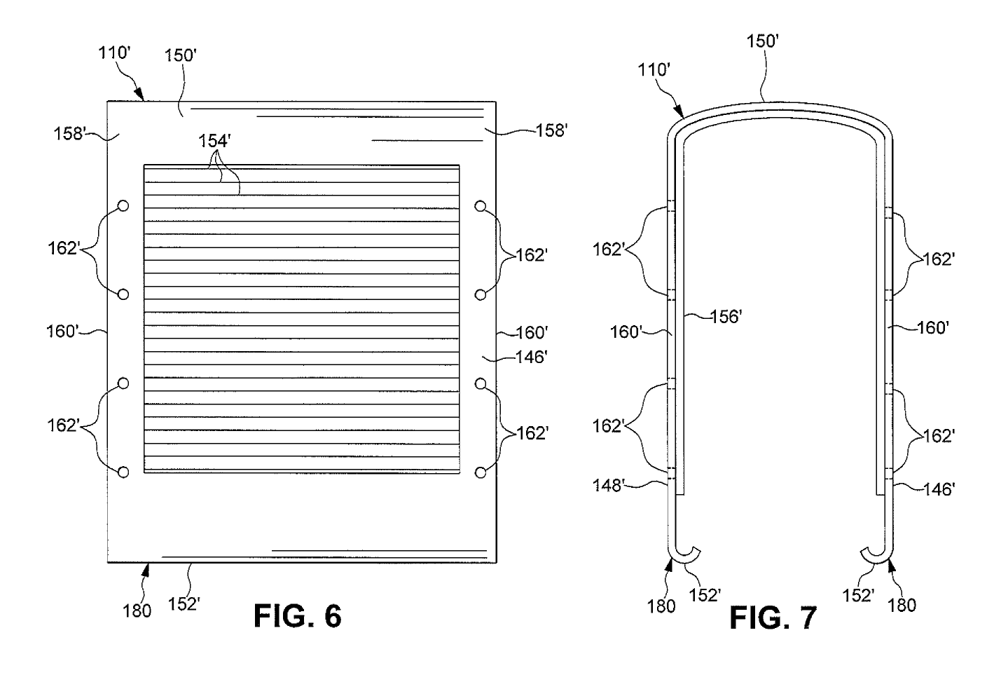

FIGS. 6 and 7 show another embodiment of the invention similar to that shown in FIGS. 2, 3, 4, and 5. Reference numerals for similar structure in respect of the description of FIGS. 2, 3, 4, and 5 are repeated in FIGS. 6 and 7 with a prime (′) symbol.

A compression enclosure apparatus 110′ includes a tab or a fastening crimp 180 formed in a first portion 146′ and in a second portion 148′ thereof. The first portion 146′ and the second portion 148′ are substantially planar. An intermediate portion 150′ is formed between the first portion 146′ and the second portion 148′. The fastening crimp 180 engages a retention channel or a retention aperture formed in a first compression plate (not shown), coupling the compression enclosure apparatus 110′ to the first compression plate and securing a fuel cell stack and a second compression plate within the compression enclosure apparatus 110′.

The fastening crimp 180 is an aduncous feature formed in the first portion 146′ and the second portion 148′ forming a lower peripheral edge 152′. Alternately, the fastening crimp 180 may be L-shaped or barb-shaped. The fastening crimp 180 is formed by bending a segment of the first portion 146′ towards the second portion 148′ when formed in the first portion 146′. When the fastening crimp 180 is formed in the second portion 148′ a segment of the second portion 148′ is bent towards the first portion 146′.

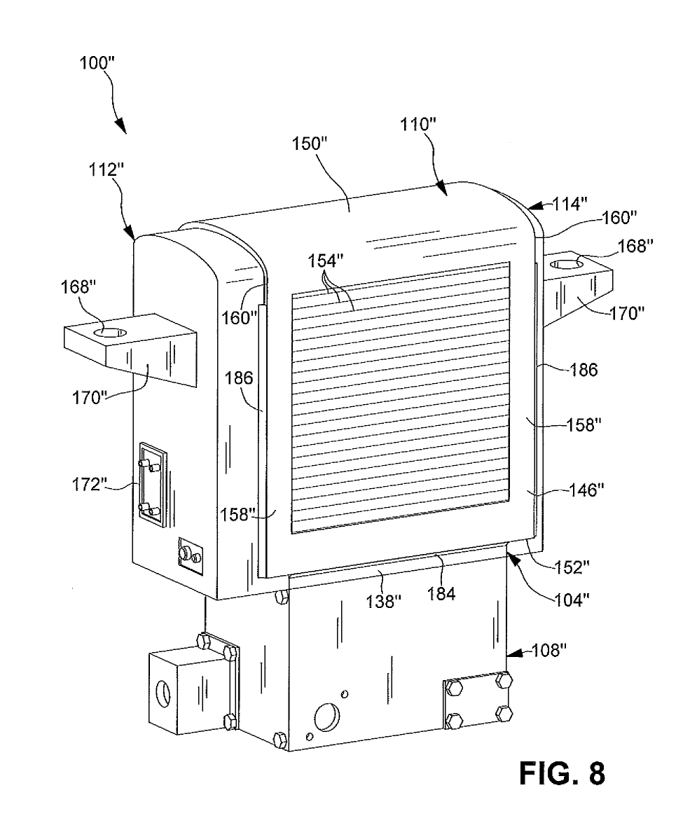

FIG. 8 shows another embodiment of the invention similar to that shown in FIGS. 2, 3, 4, and 5. Reference numerals for similar structure in respect of the description of FIGS. 2, 3, 4, and 5 are repeated in FIG. 8 with a double prime (″) symbol.

A compression enclosure apparatus 110″ is welded to the first compression plate 104″. A retention weld 184 is formed between the first compression plate 104″ and the lower peripheral edge 152″ of the first portion 146″. The retention weld 184 is also formed between the first compression plate 104″ and the lower peripheral edge 152″ of the second portion (not shown). A length of the first portion 146″ and the second portion may be adjusted to optimize a strength and a position of the retention welds 184. Further, a feature or a plurality of features such as apertures or slots may be formed in the first portion 146″ and the second portion. A weld or a plurality of welds formed in the feature or the plurality of features may increase a strength of the coupling of the compression enclosure apparatus 110″ to the first compression plate 104″. Alternately, the compression enclosure apparatus 110″ may be spot welded or inductively welded to the first compression plate 104″.

A first rigid structure 112″ and a second rigid structure 114″ may also be welded to the compression enclosure apparatus 110″. A retention weld 186 is formed between the first rigid structure 112″ and the lateral peripheral edge 160″ of the first portion 146″ and the second portion. The retention weld 186 is also formed between the second rigid structure 114″ and the lateral peripheral edge 160″ of the first portion 146″ and the second portion. The retention weld 186 may also be formed between the intermediate portion 150″ and the first rigid structure 112″ and the second rigid structure 114″. Further, a feature or a plurality of features such as apertures or slots may be formed in the first portion 146″ and the second portion adjacent the lateral peripheral edge 160″ of the first portion 146″ and the second portion. A weld or a plurality of welds formed in the feature or the plurality of features may increase a strength of the coupling of the compression enclosure apparatus 110″ to the first rigid structure 112″ and the second rigid structure 114″. Alternately, the compression enclosure apparatus 110″ may be spot welded or inductively welded to the first rigid structure 112″ and the second rigid structure 114″. It should be noted that any combination of welds and retention features may be used to couple the compression enclosure apparatus 110″ to the first compression plate 104″, the first rigid structure 112″, and the second rigid structure 114″.

In use, the fuel cell system 100, 100″ including the compression enclosure apparatus 110, 110′, 110″ may be used to minimize a number of components required to retain compression of a fuel cell stack 102, minimize a mass of the fuel cell system 100, 100″, and simplify a design of the fuel cell system 100, 100″.

To assemble the fuel cell system 100, 100″, the first compression plate 104, 104″ is placed on a support surface. Next, the plurality of bipolar plates 116 and the plurality of unitized electrode assemblies are stacked on the first compression plate 104, 104″. The second compression plate 106 is then disposed on the fuel cell stack 102, 102″. The first compression plate 104, 104″, the fuel cell stack 102, 102″, and the second compression plate 106 are aligned using a plurality of datum pins (not shown) disposed therethrough. Alternately, the inner surface or a portion of the compression enclosure apparatus 110, 110′, 110″ may be used to align the first compression plate 104, 104″, the fuel cell stack 102, 102″, and the second compression plate 106. The compression enclosure apparatus 110, 110′, 110″ is disposed over the second compression plate 106, the fuel cell stack 102, and the first compression plate 104, 104″. An air gap may be formed between the insulating layer 156, 156′ and the fuel cell stack 102. A plurality of features may be formed in or disposed on the second compression plate 106 and the compression enclosure apparatus 110, 110′, 110″ to properly align the compression enclosure apparatus 110, 110′, 110″

The intermediate portion 150, 150′, 150″ is disposed against the second compression plate 106 and a force from a press or other device is applied thereto in a direction substantially parallel to a stacking direction of the fuel cell stack 102. As the support surface resists the force, the fuel cell stack 102 is compressed. Upon a desired amount of force being applied, the force applied remains constant and the first portion 146, 146′, 146″ and the second portion 148, 148′ of the compression enclosure apparatus are in position for forming the fastening points 144 therein. In order to maintain adequate sealing and good conductivity between the plurality of bipolar plates 116, the fuel cell stack 102 remains in a compressed state. As a non-limiting example, the fuel cell stack 102 requires at least about 4 tons of compressive force applied thereto.

A second press having a plurality of punches corresponding to the retention apertures 136 may be positioned using the first compression plate 104 as a reference point. To couple the compression enclosure apparatus 110 to the first compression plate 104, the second press applies a force to the first portion 146, forming the fastening points 144 therein and coupling the first portion 146 to the first compression plate 104. The retention apertures 136 act as a plurality of dies corresponding to the plurality of punches. The second press or a third press applies a force to the second portion 148, forming the fastening points 144 therein and coupling the second portion 148 to the first compression plate 104. The fastening points 144 in the first portion 146 and the second portion 148 may be formed simultaneously or separately. Alternately, a fastener or a plurality of fasteners may be formed in the first compression plate 104, the fastener or the plurality of fasteners engaging a retention feature or a plurality of retention features formed in the compression enclosure apparatus 110. A plurality of fasteners disposed in the plurality of apertures 153 militate against the lower peripheral edge 152 of the compression enclosure apparatus 110 from pulling away from the first compression plate 104.

To form the fastening crimp 180 of the compression enclosure apparatus 110′ a second press may be used. The second press applies a force to the first portion 146, forming the fastening crimp 180 and coupling the first portion 146 to the first compression plate. The second press or a third press applies a force to the second portion 148, forming the fastening crimp 180 therein and coupling the second portion 148 to the first compression plate. The fastening crimp 180 in the first portion 146 and the second portion 148 may be formed simultaneously or separately.

A welder is used to form the retention welds 184, 186. The welder, which may be manually or automatically operated, forms the retention welds 184 between the first compression plate 104″ and the lower peripheral edge 152″, coupling the first portion 146″ and the second portion to the first compression plate 104″. After the retention welds 184 are formed, the press may be released. The retention welds 186 are then formed between the first rigid structure 112″ and the lateral peripheral edge 160″ of the first portion 146″ and the second portion, coupling the first rigid structure 112″ to the compression enclosure apparatus 110″. Similarly, the retention welds 186 are then formed between the second rigid structure 114″ and the lateral peripheral edge 160″ of the first portion 146″ and the second portion, coupling the second rigid structure 114″ to the compression enclosure apparatus 110″. The retention welds 184, 186 may be formed simultaneously or separately. The retention welds 184, 186 are well suited for the fuel cell system 100″ where permanent attachment of the compression enclosure apparatus 110″ is desired.

The compressive force stored in the fuel cell stack 102 exerts a tensile force substantially equal thereto in the compression enclosure apparatus 110, 110′, 110″. The top face 140, being arch-shaped, distributes the compressive force across the intermediate portion 150, 150′, 150″, resulting in the tensile force in the first portion 146, 146′, 146″ and the second portion 148, 148′. As the compressive force is distributed to the intermediate portion 150, 150′, 150″ through the second compression plate 106, the intermediate portion 150, 150′, 150″ militates against a plurality of stress points forming in the compression enclosure apparatus 110, 110′, 110″. Further, the top face 140, being arch-shaped, permits a mass of the second compression plate 106 to be reduced as the compressive force is distributed across the surface area of the top face 140.

After the compression enclosure apparatus 110, 110′, 110″ is coupled to the first compression plate 104, 104″, assembly of the fuel cell system 100, 100″ may continue. The lower end unit 108, 108″ is then coupled to the first compression plate 104, 104″ and the first rigid structure 112, 112″ and the second rigid structure 114, 114″ are coupled to the structural interface portion 158, 158′, 158″ to complete the fuel cell system 100, 100″

When mounted to the vehicle chassis or other structure, the fuel cell system 100, 100″ may be subject to a mounting load and a dynamic load. The mounting points 168, 168″ are used to secure the fuel cell system to the vehicle chassis or other structure. As the first compression plate 104, 104″ and the second compression plate 106 can respectively withstand the compressive and tensile forces exerted by the fuel cell stack 102 and the compression enclosure apparatus 110, 110′, 110″, the first compression plate 104, 104″ and the second compression plate 106 can similarly withstand forces exerted by the first rigid structure 112, 112″ and the second rigid structure 114, 114″.

The mounting load may be exerted by a gravitational force, forces between the components comprising the fuel cell system 100, 100″, or by the vehicle chassis or other structure. Coupling of the first rigid structure 112, 112″ and the second rigid structure 114, 114″ to the compression enclosure apparatus 110, 110′, 110″ while the first rigid structure 112, 112″ and the second rigid structure 114, 114″ abut the first compression plate 104, 104″ and the second compression plate 106 distributes the mounting load to or from the mounting points 168, 168″ without imparting forces directly to the fuel cell stack 102 from a side of the fuel cell stack 102 adjacent the first rigid structure 112, 112″, the second rigid structure 114, 114″, the first portion 146, 146′, 146″, and the second portion 148, 148′. Further, as the compression enclosure apparatus 110, 110′, 110″ is coupled to the first rigid structure 112, 112″ and the second rigid structure 114, 114″, the mounting load may be distributed across the compression enclosure apparatus 110, 110′, 110″ as tensile forces by the first rigid structure 112, 112″ and the second rigid structure 114, 114″.

The dynamic load may be exerted on the fuel cell system 100, 100″ by inertial forces of the fuel cell system 100, 100″, inertial forces of the vehicle, and forces imparted by an environment of the vehicle during vehicle operation. The tensile force in the compression enclosure apparatus 110, 110′, 110″ and the rigidizing features 154, 154′, 154″ formed therein militate against a flexing of the compression enclosure apparatus 110, 110′, 110″ when the fuel cell system 100, 100″ is imparted with the dynamic load. Coupling of the first rigid structure 112, 112″ and the second rigid structure 114, 114″ to the compression enclosure apparatus 110, 110′, 110″ while the first rigid structure 112, 112″ and the second rigid structure 114, 114″ abut the first compression plate 104, 104″ and the second compression plate 106 distributes the dynamic load to or from the mounting points 168, 168″ without imparting forces to the fuel cell stack 102 from a side of the fuel cell stack 102, 102″ adjacent the first rigid structure 112, 112″, the second rigid structure 114, 114″, the first portion 146, 146′, 146″, and the second portion 148, 148. Further, as the compression enclosure apparatus 110, 110′, 110″ is coupled to the first rigid structure 112, 112″ and the second rigid structure 114, 114″, the dynamic load may be distributed across the compression enclosure apparatus 110, 110′, 110″ as tensile forces by the first rigid structure 112, 112″ and the second rigid structure 114, 114″.

The insulating layer 156, 156′ militates against heat loss from the fuel cell stack 102 to an ambient environment in which the fuel cell system 100, 100″ is located. During a startup procedure in a cold environment, the fuel cell system 100, 100″ may be operated at a low output until a desired operating temperature is reached. The insulating layer 156, 156′ minimizes an amount of time the fuel cell system 100, 100″ is operated at a low output during the startup procedure. Further, the insulating layer 156, 156′ disposed on the inner surface of the compression enclosure apparatus facilitates service of the fuel cell system 100, 100″ and militates against damage that may occur to an insulating layer disposed on an outer surface of the fuel cell system 100, 100″.

In addition to facilitating communication through the first rigid structure 112, 112″ and the second rigid structure 114, 114″, the port 172, 172″ facilitates service access to the fuel cell system 100, 100″. The port 172, 172″ may militate against removal of the fuel cell system 100, 100″ from the vehicle during servicing by provide service access for the fuel cell stack 102 or the component disposed in the interior cavity of the first rigid structure 112, 112″ and the second rigid structure 114, 114″. A service time and a service cost of the fuel cell system 100, 100″ may be reduced by the port 172, 172″.

While certain representative embodiments and details have been shown for purposes of illustrating the invention, it will be apparent to those skilled in the art that various changes may be made without departing from the scope of the disclosure, which is further described in the following appended claims.

What is claimed is:

1. A fuel cell system comprising:
a fuel cell stack having a first end and a second end, the stack including at least one fuel cell;
a first compression plate disposed adjacent the first end of the fuel cell stack;
a second compression plate disposed adjacent the second end of the fuel cell stack; and
a compression enclosure apparatus further comprising:
a unitary main body having a first fastening point, a second fastening point, and an intermediate portion, wherein the first fastening point and the second fastening point are coupled to the first compression plate and the intermediate portion is disposed adjacent the second compression plate.

2. The fuel cell system of claim 1, wherein the compression enclosure apparatus is formed from a sheet metal.

3. The fuel cell system of claim 1, wherein the compression enclosure apparatus includes a plurality of rigidizing features formed therein.

4. The fuel cell system of claim 1, wherein the compression enclosure apparatus includes an insulating layer interposed between the compression enclosure apparatus and the fuel cell stack.

5. The fuel cell system of claim 1, wherein the compression enclosure apparatus is generally U-shaped.

6. The fuel cell system of claim 1, wherein the first fastening point is formed in a first end of the unitary main body and the second fastening point is formed in a second end of the unitary main body.

7. The fuel cell system of claim 1, wherein a width of the compression enclosure apparatus is greater than a width of the fuel cell stack.

8. The fuel cell system of claim 1, further comprising an end unit containing at least one stack support system, the end unit disposed adjacent the first compression plate.

9. The fuel cell system of claim 1, further comprising a rigid structure disposed adjacent the fuel cell stack, the rigid structure coupled to the compression enclosure apparatus.

10. The fuel cell system of claim 1, wherein at least one of the first fastening point and the second fastening point is a tab formed by a stamping process.

11. The fuel cell system of claim 1, wherein at least one of the first fastening point and the second fastening point is a distal end of the compression enclosure apparatus.

12. The fuel cell system of claim 1, wherein at least one of the first fastening point and the second fastening point is coupled to the first compression plate with a weld.

13. The fuel cell system of claim 1, further comprising a plurality of retention apertures formed in the first compression plate.

14. The fuel cell system of claim 13, wherein the plurality of retention apertures formed in the first compression plate cooperate with at least one of the first fastening point and the second fastening point to couple the compression enclosure apparatus to the first compression plate.

15. The fuel cell system of claim 13, wherein the plurality of retention apertures and a press cooperate to form at least one of the first fastening point and the second fastening point and to couple the compression enclosure apparatus to the first compression plate.

16. A fuel cell system comprising:
a fuel cell stack having a first end and second end, the stack including at least one fuel cell;
a first compression plate disposed adjacent the first end of the fuel cell stack;
a second compression plate disposed adjacent the second end of the fuel cell stack; and
a generally U-shaped compression enclosure apparatus further comprising:
a unitary main body having at least one first tab formed in a first end thereof, at least one second tab formed in a second end thereof, and an intermediate portion, wherein the at least one first tab and the at least one second tab are coupled to the first compression plate and the intermediate portion is disposed adjacent the second compression plate.

17. The fuel cell system of claim 16, wherein a width of the compression enclosure apparatus is greater than a width of the fuel cell stack

18. The fuel cell system of claim 16, wherein a plurality of retention apertures formed in the first compression plate cooperate with the at least one first tab and the at least one second tab to couple the compression enclosure apparatus to the first compression plate.

19. The fuel cell system of claim 16, wherein a plurality of retention apertures formed in the first compression plate and a press cooperate to form the at least one first tab and the at least one second tab and to couple the compression enclosure apparatus to the first compression plate.

20. A method for assembling a fuel cell system comprising:
providing a compression enclosure apparatus having a unitary main body with a first fastening point, a second fastening point, and an intermediate portion;
providing a first compression plate;
providing a fuel cell stack having a first end and second end, the stack comprising at least one fuel cell;
providing a second compression plate;
disposing the second compression plate in the compression enclosure apparatus;
disposing the fuel cell stack in the compression enclosure apparatus, the second end of the fuel cell stack disposed against the second compression plate;
disposing the first compression plate against the first end of the fuel cell stack;
applying a compressive load to one of the first compression plate and the compression enclosure apparatus to compress the fuel cell stack;
coupling the compression enclosure apparatus to the first compression plate; and
removing the compressive load.
